(19) United States
(12) Patent Application Publication
(10) Pub. No.: US 2012/0099867 A1
(43) Pub. Date: Apr. 26, 2012

(54) WAVELENGTH MULTIPLEXING OPTICAL COMMUNICATION DEVICE AND OPTICAL DISPERSION COMPENSATION METHOD

(76) Inventors: Atsuya Hotta, Tokyo (JP); Masaki Sato, Tokyo (JP)

(21) Appl. No.: 13/254,134

(22) PCT Filed: Mar. 1, 2010
(86) PCT No.: PCT/JP2010/001382

§ 371 Date: Nov. 21, 2011

(30) Foreign Application Priority Data
Mar. 3, 2009 (JP) 2009-049842

(51) Int. Cl. H04J 14/02

(52) U.S. Cl. 398/81

(57) ABSTRACT

A wavelength multiplexing optical communication device having an optical dispersion-compensating function compensating for waveform variation of an optical signal due to optical dispersion of a transmission line determines optimum dispersion-compensating values causing a minimum error rate with respect to pre-installed wavelength channels, produces a dispersion map of the transmission line based on optimum dispersion-compensating values, predicts an initial value of a dispersion-compensating value per a newly added wavelength channel with reference to the dispersion map, and starts scanning at the initial value so as to determine an optimum dispersion-compensating value of the newly added wavelength channel, thus updating the dispersion map by adding the optimum dispersion-compensating value of the newly added wavelength channel. Thus, it is possible to set an optimum dispersion-compensating value per each wavelength channel with a high precision, thus shortening the setting time.

### TECHNICAL FIELD

The present invention relates to optical dispersion compensation methods for compensating degradation of waveforms of optical signals due to optical dispersion, and wavelength multiplexing optical communication devices having optical dispersion-compensating functions.

The present application claims priority on Japanese Patent Application No. 2009-49842 filed Mar. 3, 2009, the entire content of which is incorporated herein by reference.

### BACKGROUND ART

An optical dispersion compensation method conventionally applied to a wavelength multiplexing optical communication device will be described with reference to FIG. 14. FIG. 14 is a block diagram showing the constitution of a wavelength multiplexing optical communication device 100. When an optical signal whose waveform is degraded due to optical dispersion is transmitted via a transmission line 101, a dispersion compensator 102 compensates for degradation of the waveform of the optical signal, which is then supplied to an optical signal receiver 103. The optical signal receiver 103 splits the dispersion-compensated optical signal into an electric data signal and an electric clock signal, which are supplied to a signal processing circuit 104 and subjected to predetermined signal processing. At this time, a calculation circuit 105 calculates a dispersion-compensating value based on signal information from the signal processing circuit 104, thus feeding it back to the dispersion compensator 102. Based on the calculated dispersion-compensating value, the dispersion compensator 102 compensates for degradation of the waveform of the optical signal supplied via the transmission line 101. Thus, the dispersion-compensated optical signal is transmitted to the optical signal receiver 103.

Various types of optical dispersion compensating techniques have been developed, wherein Patent Document 1, for example, discloses an optical receiver device which aims to shorten the time for actually setting dispersion-compensating values based on dispersion-compensating values stored in advance. Patent Document 2 discloses a dispersion-compensating value setting method of an optical transmission device which aims to shorten the time for setting dispersion-compensating values by automatically setting an initial compensating value of a variable dispersion compensator based on a default value of an existing optical transmission unit when adding an optical transmission unit with a different wavelength. Patent Document 3 discloses a wavelength dispersion compensation control system utilizing characteristics in which residual wavelength dispersion varies in a negative direction in response to a high peak value of a received signal, while residual wavelength dispersion varies in a positive direction in response to a low peak value of a received signal, which determines a degree of wavelength dispersion compensation in response to a rapid variation of wavelength dispersion, thus varying wavelength dispersion-compensating values close to an approximate value of an optimum dispersion-compensating value at a high speed based on wavelength dispersion variation codes.

### PRIOR ART DOCUMENT

### Patent Document

Patent Document 1: Japanese Patent Application Publication No. 2008-72555
Patent Document 2: Japanese Patent Application Publication No. 2008-228002
Patent Document 3: Japanese Patent Application Publication No. 2004-304559

### SUMMARY OF THE INVENTION

### Problem to be Solved by the Invention

The conventional optical dispersion compensation of the wavelength multiplexing optical communication device suffers from the following problems.

A first problem is that dispersion values representing variations of waveforms of optical signals depend upon conditions of transmission lines since dispersion values of optical signals depend upon types and lengths of optical fibers used for transmission lines. For this reason, when optical signals are individually subjected to dispersion compensation per each wavelength channel, the dispersion compensator 102 needs to confirm an optimum dispersion-compensating value per each optical signal by scanning the entire dispersion compensable range.

A second problem is that dispersion-compensating scanning regarding optical signals needs to be performed with respect to all wavelength channels since the dispersion compensator 102 performs dispersion compensation on each optical signal with respect to a new wavelength channel additionally allocated to the wavelength multiplexing optical communication device. This increases the time for setting an optimum dispersion-compensating value per each optical signal.

A third problem is that, since dispersion-compensating values individually compensating for dispersions of optical signals per each wavelength channel cannot be determined in advance, the dispersion compensator 102 needs to scan the entire dispersion compensable range of optical signals, confirm dispersion-compensating values causing minimum error rates of data signals, and set optimum dispersion-compensating values of optical signals. That is, a long time is needed to set optimum dispersion-compensating values compensating for degradation of waveforms of optical signals since it is necessary to scan the entire dispersion compensable range of optical signals, confirm error rates of data signals, and set optimum dispersion-compensating values of optical signals subjected to dispersion compensation.

Patent Document 1 is able to control dispersion compensation by confirming peak values of waveforms of optical signals input to a receiver, but unable to optimally control dispersion compensation based on predicted dispersion values with respect to an additional wavelength channel. Patent Document 2 stores characteristic data, such as reference wavelengths, dispersion coefficients, and slope values in advance, thus compensating for dispersions of optical signals by calculating an initial value of dispersion compensation based on characteristic data with respect to an additional optical transmission unit (or an additional wavelength signal). However, Patent Document 2 is unable to predict a dispersion value of an additional wavelength signal based on dispersion-compensating values of existing wavelength signals or dispersion values produced via linearly interpolation of wavelengths. Patent Document 2 is unable to optimally control dispersion compensation at a high precision and at a high speed. Patent Document 3 discloses a dispersion compensation method for individual optical signals with respect to additional wavelength signals, which performs dispersion compensation based on an initial set value corresponding to a wavelength closest to an additional wavelength signal. Patent Document 3 is unable to shorten the scanning time of dispersion compensation of optical signals based on a predicted dispersion value of an additional wavelength signal. In addition, Patent Document 3 is unable to cope with erroneous conditions when detecting defects and variations of transmission lines.

### Means for Solving the Problem

The present invention is made under the foregoing circumstances, wherein the object thereof is to set an optimum dispersion-compensating value compensating for degradation of a waveform of an optical signal input via a transmission line at a high speed, thus shortening the time for setting the optimum dispersion-compensating value.

The present invention is directed to a wavelength multiplexing optical communication device having an optical dispersion-compensating function compensating for degradation of a waveform of an optical signal due to optical dispersion of a transmission line, wherein a dispersion map of a transmission line is produced based on an optimum dispersion-compensating value preset to a pre-installed wavelength channel; an initial value of a dispersion-compensating value is predicted with reference to the dispersion map with respect to a newly added wavelength channel; and subsequently, scanning is started at the initial value of the dispersion-compensating value so as to determine the optimum dispersion-compensating value of the newly added wavelength channel, thus updating the dispersion map.

This wavelength multiplexing optical communication device includes a signal processing circuit that determines an optimum dispersion-compensating value causing a minimum error rate detected by scanning dispersion-compensating values with respect to a pre-installed wavelength channel, and a recording/calculation circuit that produces a dispersion map based on the optimum dispersion-compensating value, predicts an initial value of the dispersion-compensating value with respect to a newly added wavelength channel with reference to the dispersion map, performs scanning starting from the initial value, determines the optimum dispersion-compensating value of the newly added wavelength channel, and updates the dispersion map.

Additionally, the present invention is directed to an optical dispersion compensation method realizing the optical dispersion-compensating function. Furthermore, the present invention is directed to a program describing the optical dispersion compensation method loaded and executed by a computer.

### Effect of the Invention

The present invention produces the dispersion map based on the optimum dispersion-compensating value, which has been already determined with respect to the pre-installed wavelength channel, thus enabling prediction of wavelength characteristics due to optical dispersion of an optical transmission line. Thus, it is possible to shorten the time for setting the optimum dispersion-compensating value since scanning is started at an initial value of a dispersion-compensating value which is predicted with respect to a newly added wavelength channel with reference to the dispersion map. Additionally, it is possible to improve the accuracy of the dispersion map since the dispersion map is successively updated by adding a new optimum dispersion-compensating value which is determined with respect to a newly added wavelength channel. This reduces a difference or error between a predicted value of a dispersion-compensating value and an actual optimum dispersion-compensating value, thus further shortening the time for setting the optimum dispersion-compensating value due to an update of the dispersion map and further improving its accuracy.

### BRIEF DESCRIPTION OF THE DRAWINGS

FIG. 1 A block diagram showing the overall constitution of a wavelength multiplexing optical communication system adopting the present invention.

FIG. 2 A block diagram showing essential parts of a wavelength multiplexing optical communication device according to Embodiment 1 of the present invention.

FIG. 3 A flowchart showing a dispersion-compensating value setting process with respect to “wavelength channel 1” installed in the wavelength multiplexing optical communication device.

FIG. 4 A characteristic graph showing the relationship between error rates and dispersion-compensating values scanned by a dispersion compensator.

FIG. 5 A flowchart showing a dispersion-compensating value setting process with respect to “wavelength channel 2” installed in the wavelength multiplexing optical communication device.

FIG. 6 A dispersion map which is produced by plotting the relationship between optimum dispersion-compensating values and wavelength channels.

FIG. 7 A flowchart showing a dispersion-compensating value setting process with respect to “wavelength channel M” additionally installed in the wavelength multiplexing optical communication device.

FIG. 8 A dispersion map used for predicting the optimum dispersion-compensating value with respect to wavelength channel M.

FIG. 9 A characteristic graph showing the relationship between error rates and dispersion-compensating values scanned by the dispersion compensator.

FIG. 10 (a) A dispersion map which is produced based on optimum dispersion-compensating values of wavelength channels 1 and 2; (b) a dispersion map which is updated by adding an optimum dispersion-compensating value with respect to wavelength channel 3 additionally installed; (c) a dispersion map which is updated by further adding optimum dispersion-compensating values with respect to wavelength channels additionally installed.

FIG. 11 A block diagram showing essential parts of a wavelength multiplexing optical communication device according to Embodiment 2 of the present invention.

FIG. 12 A dispersion map which is produced in Embodiment 2 of the present invention.

FIG. 13 A dispersion map which is produced in Embodiment 3 of the present invention.

FIG. 14 A block diagram showing the constitution of a conventional wavelength multiplexing optical communication device.

### MODE FOR CARRYING OUT THE INVENTION

A wavelength multiplexing optical communication device having an optical dispersion-compensating function according to the present invention will be described. The wavelength multiplexing optical communication system produces a dispersion map of a transmission line based on dispersion-compensating values applied to individual optical signals with respect to pre-installed wavelength channels. With respect to a newly added wavelength channel, an initial value is determined by predicting a dispersion-compensating value of an optical signal which is predicted from the dispersion map produced in advance. Scanning is started at the initial value so as to determine an optimum dispersion-compensating value with respect to the newly added wavelength channel. This shortens the time for setting an optimum dispersion-compensating value of an optical signal, thus enabling high-speed and high-precision dispersion compensation on optical signals.

In other words, the wavelength multiplexing optical communication device records dispersion-compensating values (or dispersion values) of individual optical signals per installed wavelength channel and produces a dispersion map of a transmission line before performing dispersion compensation on individual optical signals per wavelength channel. The dispersion map indicates the relationship between wavelengths of wavelength channels and optimum dispersion-compensating values. With respect to a newly added wavelength channel, an initial value is determined by predicting a dispersion-compensating value with reference to the dispersion map of the transmission line which is produced based on dispersion-compensating values of pre-installed wavelength channels. Scanning is started at the initial value and performed on dispersion-compensating values of individual optical signals, thus actually determining an optimum dispersion-compensating value. Thus, it is possible to achieve high-speed dispersion compensation on optical signals.

Hereinafter, Embodiments 1 to 3 of the present invention will be described in detail with reference to the accompanying drawings. In the following description regarding each embodiment, the same constituent parts are designated by the same reference numerals; hence, duplicate descriptions will be omitted.

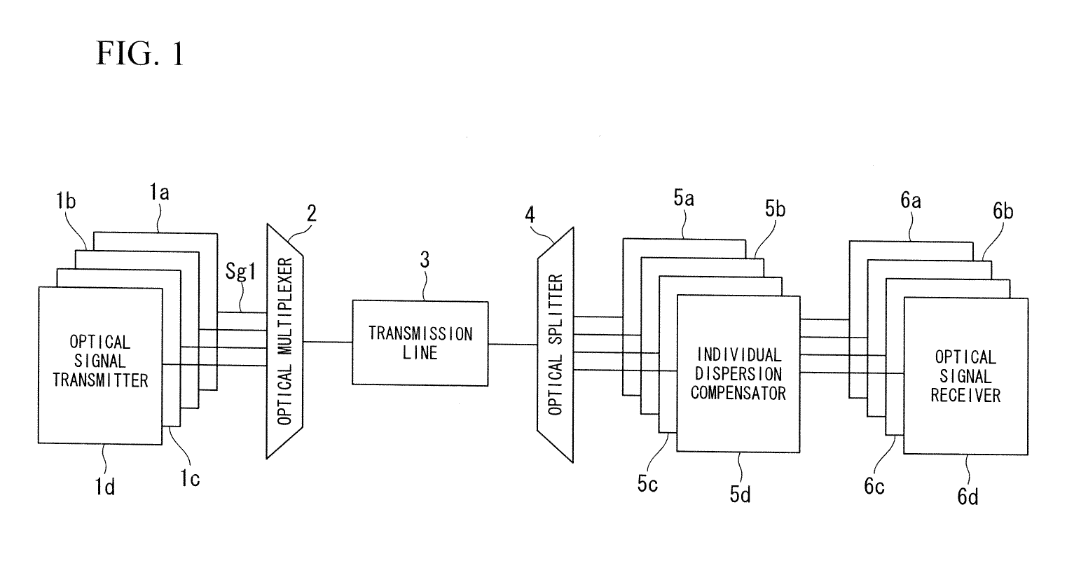

First, an improvement of the dispersion compensation method of the wavelength multiplexing optical communication system regarding each embodiment over the prior art will be described. FIG. 1 is a block diagram showing the overall constitution of a wavelength multiplexing optical communication system. This wavelength multiplexing optical communication system is configured such that optical signals of four wavelength channels are transmitted from an optical signal transmitter 1 to an optical signal receiver 6.

In FIG. 1, four optical signal transmitters 1a, 1b, 1c, and 1d transmit optical signals Sg1 to an optical multiplexer 2. Optical signals Sg1 are subjected to wavelength multiplexing in the optical multiplexer 2 and then transmitted to an optical splitter 4 via a transmission line 3. The optical splitter 4 splits wavelength-multiplexed optical signals into optical signals of four wavelength channels, which are supplied to individual dispersion compensators 5a, 5b, 5c, and 5d. Optical signals of four wavelength channels are subjected to dispersion compensation in the individual dispersion compensators 5a to 5d and then supplied to optical signal receivers 6a, 6b, 6c, and 6d. While optical signals Sg1 output from the optical signal transmitters 1a to 1d are transmitted through the transmission line 3, waveform variations occur under the influence of optical dispersion depending upon the length or type of an optical fiber constituting the transmission line 3.

Optical signals, undergoing waveform variations due to optical dispersion in the transmission line 3, are corrected (i.e. dispersion-compensated) in their waveform variations by means of the individual dispersion compensators 5a to 5d and then supplied to the optical signal receivers 6a to 6d. Dispersion-compensated optical signals are subjected to photoelectric conversion, clock extraction, and signal-identified reproduction in the optical signal receivers 6a to 6d, so that they are divided into electric data signals and electric clock signals.

Waveforms of optical signals are dispersion-degraded due to optical dispersion in the optical fiber constituting the transmission line 3. That is, an impact of dispersion degradation to optical signals is varied due to the transmission distance of the optical fiber, the type of the optical fiber, or spectrum widths and bit rates of optical signals. Optical signals are degraded in quality while being transmitted through the transmission line 3 since optical signals output from the optical signal transmitters 1a to 1d are dispersion-degraded so as to exceed the tolerance of optical signal receivers 6a to 6d. Digital errors occur due to reproduction of dispersion-degraded optical signals; hence, it is necessary to perform dispersion compensation on optical signals per wavelength channel by means of the individual dispersion compensators 5a to 5d in advance.

In order to perform dispersion compensation on individual optical signals with the individual dispersion compensators 5a to 5d, however, it is necessary to scan the entire range of predetermined dispersion-compensable values (dispersion-compensating values) of optical signals so as to search for dispersion values causing minimum error rates because of unknown conditions of the transmission line 3 (i.e. the length and type of the optical fiber). Since optimum dispersion-compensating values for individual optical signals are determined based on those dispersion values, a long time is needed to determine optimum dispersion-compensating values.

To solve this drawback, the present invention is designed to produce a dispersion map for recording dispersion values which are determined with respect to pre-installed wavelength channels, wherein an initial value is determined by predicting a dispersion-compensating value of a newly added wavelength channel with reference to the dispersion map.

Since scanning is started at the initial value of the dispersion-compensating value which is predicted based on the dispersion map, it is unnecessary to scan the entire range of dispersion-compensable values, but it is possible to retrieve an optimum dispersion-compensating value by way of scanning in the proximate range of the initial value. Thus, it is possible to shorten the time for setting the optimum dispersion-compensating value.

The wavelength multiplexing optical communication device of the present invention has an optical dispersion-compensating function that determines an initial value by predicting a dispersion-compensating value of a newly added wavelength channel with reference to a dispersion map of the transmission line which is produced based on dispersion values of pre-installed wavelength channels among wavelength channels subjected to dispersion compensation on individual optical signals. Therefore, since scanning is started at the predicted initial value to search for an optimum dispersion-compensating value with respect to a newly added wavelength channel, it is possible to shorten the time for setting the optimum dispersion-compensating value.

Hereinafter, the wavelength multiplexing optical communication device and the optical dispersion compensation method according to the present invention will be described in conjunction with Embodiments 1 to 3.

### Embodiment 1

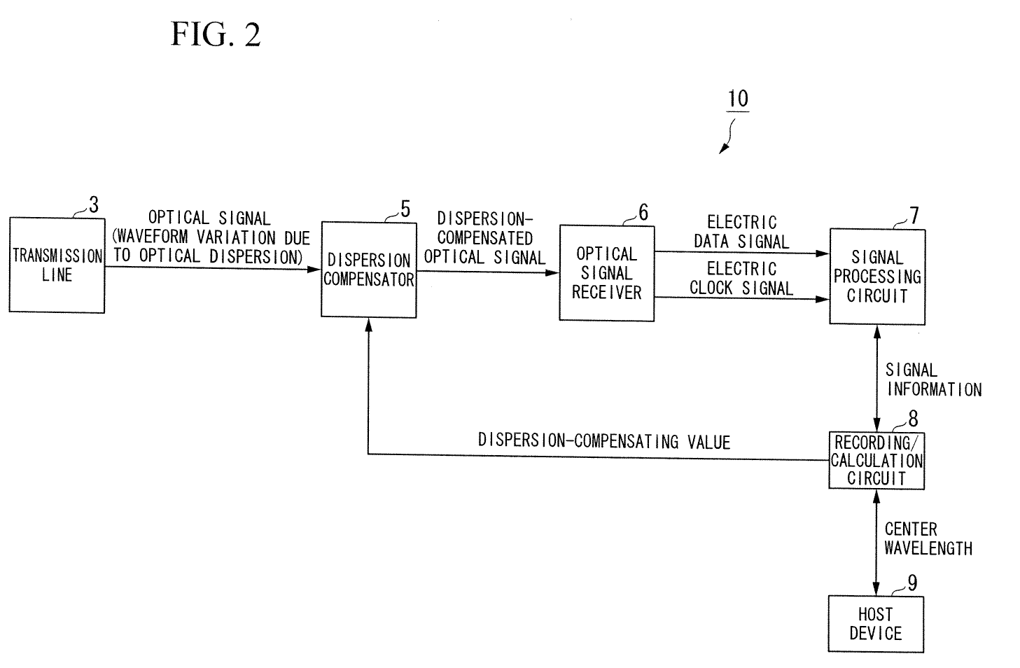

FIG. 2 is a block diagram showing essential parts of a wavelength multiplexing optical communication device 10 according to Embodiment 1. The wavelength multiplexing optical communication device 10 includes the transmission line 3 for transmitting optical signals, the dispersion compensator 5 for compensating for degradation of waveforms of optical signals, the optical signal receiver 6 for receiving dispersion-compensated optical signals, a signal processing circuit 7 for confirming error rates of optical signals, a recording/calculation circuit 8 which calculates dispersion values (dispersion-compensating values) based on signal information of the signal processing circuit 7 so as to feed back them to the dispersion compensator 5 and which produces a dispersion map predicted based on dispersion-compensating values and center wavelengths with respect to the transmission line 3, and a host device 9 managing center frequencies recorded in the recording/calculation circuit 8.

Next, the operation of the wavelength multiplexing optical communication device 10 according to Embodiment 1 will be described. Optical signals undergoing waveform variations due to optical dispersion in the transmission line 3 are supplied to the optical signal receiver 6 via the dispersion compensator 5. Optical signals are degraded in waveforms due to optical dispersion depending upon the optical fiber constituting the transmission line 3. For this reason, the dispersion compensator 5 compensates for degradation of waveforms of optical signals due to optical dispersion; thereafter, dispersion-compensated optical signals are supplied to the optical signal receiver 6.

The optical signal receiver 6 performs photoelectric conversion on optical signals so as to produce electric data signals and electric clock signals, which are forwarded to the signal processing circuit 7. The signal processing circuit 7 confirms error rates of optical signals due to the transmission line 3. Herein, the dispersion compensator 5 performs dispersion compensation to minimize error rates, so that dispersion-compensating values are recorded in the recording/calculation circuit 8 in correspondence with center wavelengths of optical signals. The recording/calculation circuit 8 produces a dispersion map which is predicted based on dispersion-compensating values and center wavelengths with respect to the transmission line 3.

With reference to the dispersion map produced by the recording/calculation circuit 8, an initial value of dispersion compensation is predicted with respect to a wavelength channel newly added to the wavelength multiplexing optical communication device 10, so that an optimum dispersion-compensating value is retrieved by scanning the proximate range of the initial value.

Next, the optical dispersion compensation method applied to the wavelength multiplexing optical communication device 10 will be described in detail.

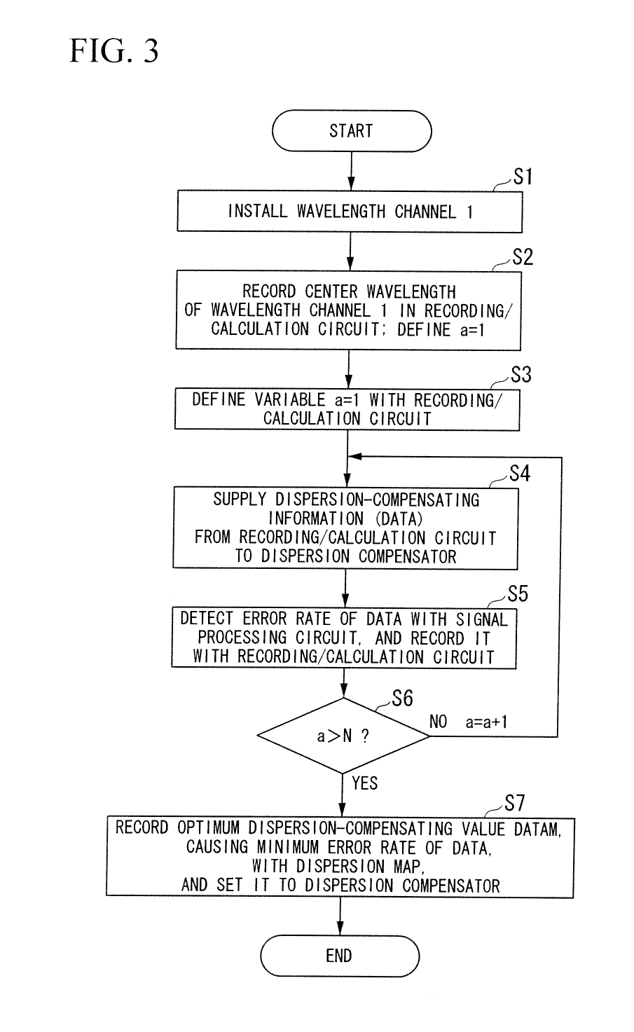

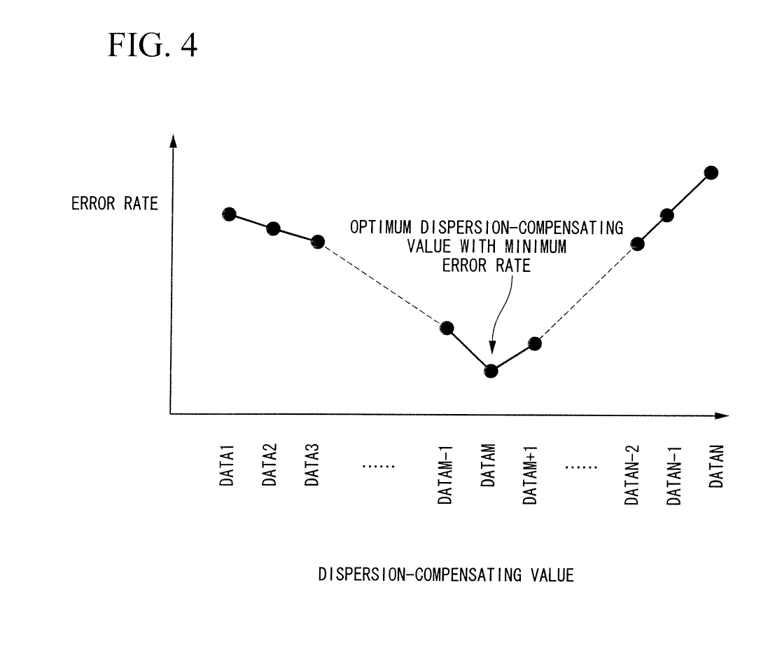

FIG. 3 is a flowchart showing a dispersion-compensating value setting process with respect to “wavelength channel 1” installed in the wavelength multiplexing optical communication device 10. FIG. 4 is a characteristic graph plotting error rates which are detected by manipulating dispersion-compensating values with the dispersion compensator 5, wherein the horizontal axis represents the dispersion-compensating value per each data, and the vertical axis represents the error rate. The optical dispersion compensation method of the wavelength multiplexing optical communication device 10 will be described with reference to FIGS. 3 and 4.

First, “wavelength channel 1” is installed in the wavelength multiplexing optical communication device 10 (step S1). Herein, the dispersion compensator 5 needs to entirely scan the dispersion-compensable range because of unknown conditions of the transmission line 3; hence, the dispersion-compensable range is equally divided by N so as to set DATA1 to DATAN. With respect to wavelength channel 1, a dispersion-compensating value, an error rate, and a center frequency detected in DATA1 are recorded in the recording/calculation circuit 8, thus defining “a=1” (step S2). Additionally, the recording/calculation circuit 8 defines “variable a=1” (step S3).

Next, the recording/calculation circuit 8 supplies a dispersion-compensating value of DATA2 to the dispersion compensator 5 (step S4). Meanwhile, the signal processing circuit 7 detects an error rate of DATA2 (see FIG. 4), which is recorded in the recording/calculation circuit 8, thus defining “variable a=2” in step S5. A series of steps S4 to S6 is repeated until the variable a reaches the number N for dividing the dispersion-compensable range. When the variable a reaches the number N, the signal processing circuit 7 designates an optimum dispersion-compensating value, i.e. DATA (DATAM in FIG. 4) indicating a minimum error rate selected from among error rates of DATA1 to DATAN, thus recording the optimum dispersion-compensating value in the dispersion map of the recording/calculation circuit 8 and setting it to the dispersion compensator 5 (step S7). Thus, setting of the optimum dispersion-compensating value per wavelength channel 1 is completed.

That is, the present embodiment measures error rates in N divisions (i.e. DATA 1 to DATAN) with respect to wavelength channel 1 so as to search for DATA (e.g. DATAM) having a minimum error rate which serves as an optimum dispersion-compensating value. The optimum dispersion-compensating value is set to the dispersion compensator 5, thus achieving dispersion compensation with respect to wavelength channel 1.

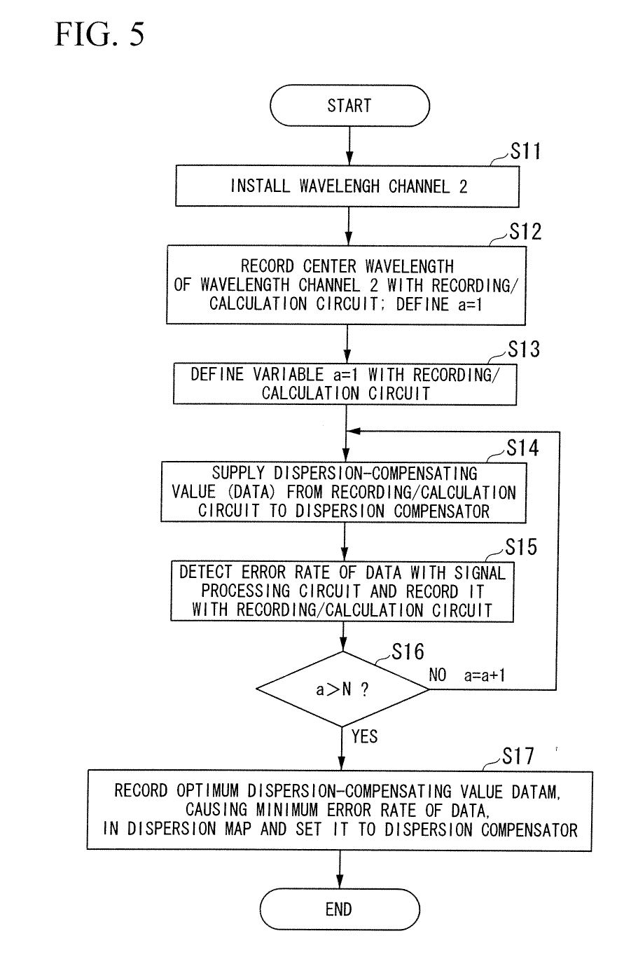

Next, a dispersion-compensating value setting process regarding “wavelength channel 2” will be described with reference to a flowchart of FIG. 5. Subsequent to the dispersion-compensating value setting process of wavelength channel 1 shown in FIG. 3, the dispersion-compensating value setting process of wavelength channel 2 shown in FIG. 5 will be performed. A series of steps S11 to S17 shown in FIG. 5 is identical to a series of steps S1 to S7 shown in FIG. 3 except that the term “wavelength channel 1” is changed to “wavelength channel 2”.

Similar to wavelength channel 1, wavelength channel 2 causes the dispersion compensator 5 to entirely scan the dispersion-compensable range, so that error rates are detected in DATA1 to DATAN, i.e. N divisions of the dispersion-compensable range. The recording/calculation circuit 8 records a dispersion-compensating value and a center wavelength with respect to wavelength channel 2 while setting DATA indicating a minimum error rate, serving as an optimum dispersion-compensating value, to the dispersion compensator 5. Additionally, the recording/calculation circuit 8 produces a dispersion map based on the dispersion-compensating value of wavelength channel 2.

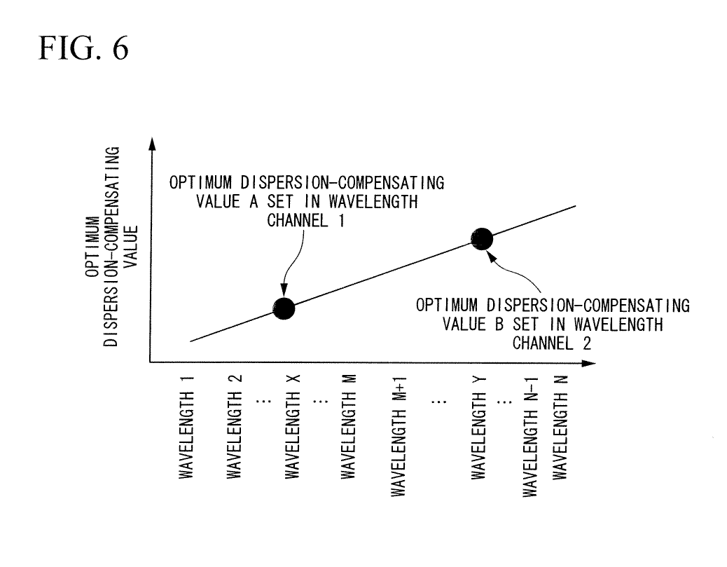

FIG. 6 shows a dispersion map which is produced by plotting the relationship between wavelength channels and dispersion-compensating values, which the recording/calculation circuit 8 sets to the dispersion compensator 5. The horizontal axis of FIG. 6 represents wavelengths 1 to N of optical signals, and the vertical axis represents optimum dispersion-compensating values. FIG. 6 shows the dispersion map which the recording/calculation circuit 8 produces after completion of setting the optimum dispersion-compensating value per wavelength channel 1 in accordance with the flowchart of FIG. 3 and after completion of setting the optimum dispersion-compensating value per wavelength channel 2 in accordance with the flowchart of FIG. 5. Herein, an optimum dispersion-compensating value A is set with respect to wavelength channel 1 corresponding to wavelength X, whilst an optimum dispersion-compensating value B is set with respect to wavelength channel 2 corresponding to wavelength Y.

The recording/calculation circuit 8 produces a dispersion map covering the entire range of wavelengths in the transmission line 3 in such a way that, as shown in FIG. 6, a line is drawn between coordinates of the optimum dispersion-compensating value A at wavelength X per wavelength channel 1 and coordinates of the optimum dispersion-compensating value B at wavelength Y per wavelength channel 2.

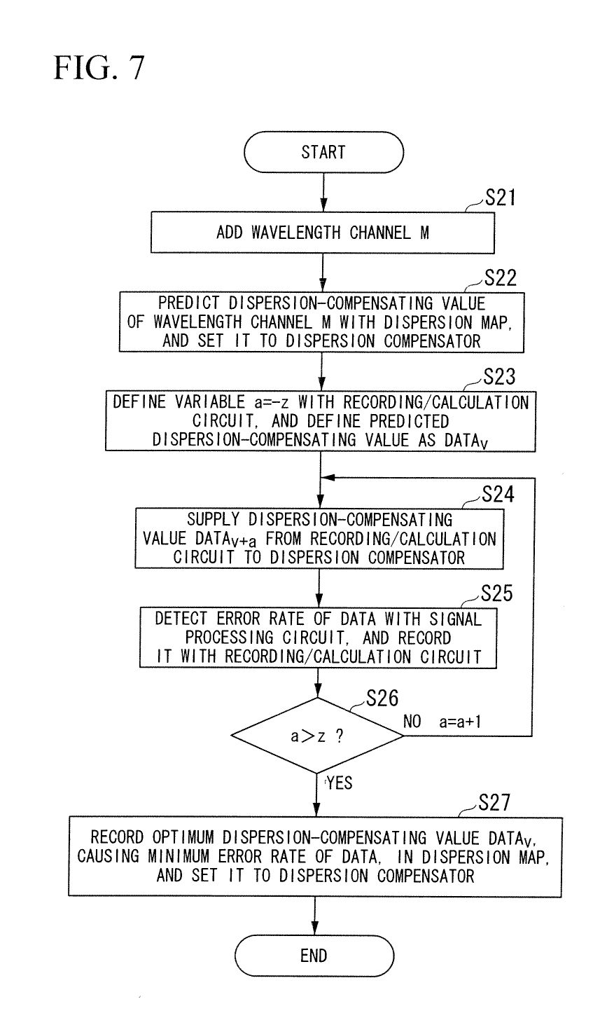

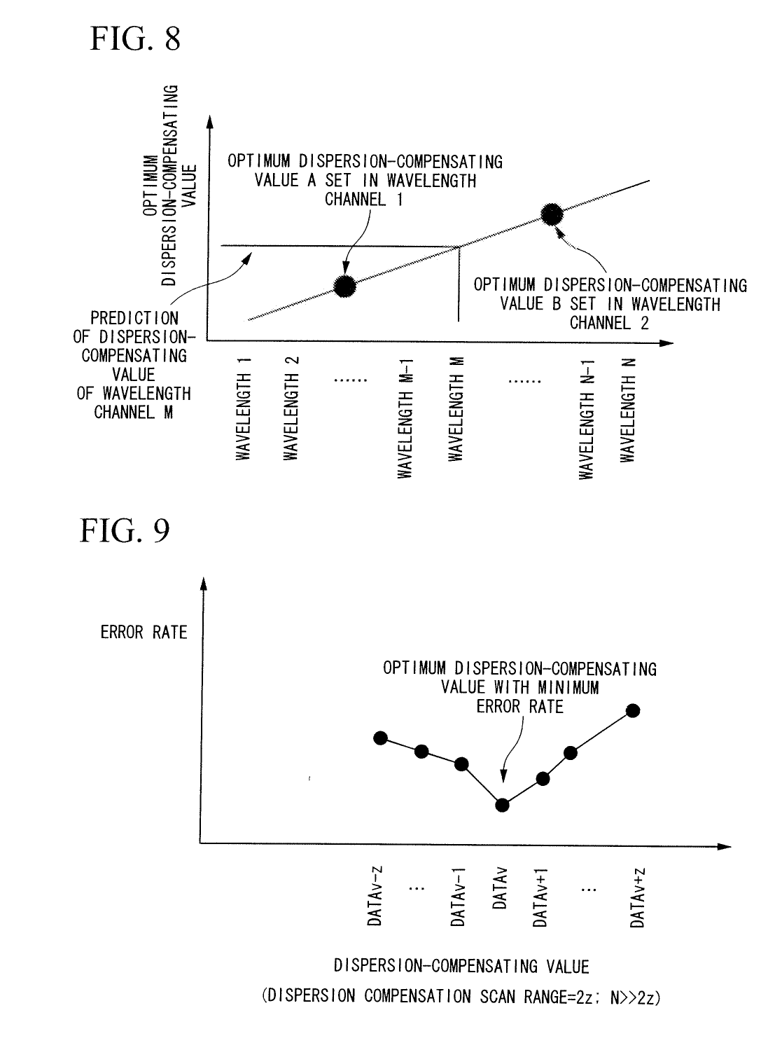

FIG. 7 is a flowchart showing a dispersion-compensating value setting process with respect to wavelength channel M newly added to the wavelength multiplexing optical communication device 10. A series of steps S21 to S27 shown in FIG. 7 is identical to a series of steps S1 to S7 shown in FIG. 3 and a series of steps S11 to S17 shown in FIG. 5 except that the terms “wavelength channel 1” and “wavelength channel 2” are changed to “wavelength channel M”. FIG. 8 shows a dispersion map used for predicting an optimum dispersion-compensating value with respect to wavelength channel M added in step S22, which is identical to the dispersion map shown in FIG. 6. FIG. 9 shows a dispersion map plotting error rates which are detected by scanning the entire range of dispersion-compensating values with the dispersion compensator 5 in accordance with a series of steps S24 to S26. The horizontal axis of FIG. 9 shows DATAv−z to DATAv+z about DATAv.

After completion of the flowchart of FIG. 5, the flowchart of FIG. 7 is implemented to add wavelength channel M to the wavelength multiplexing optical communication device 10 (step S21). An interpolation calculation is made with reference to the dispersion map of FIG. 6 which is produced with respect to wavelength channel 1 and wavelength channel 2, thus predicting an initial value of a dispersion-compensating value of wavelength channel M, which is set to the dispersion compensator 5 (step S22). That is, the dispersion map of FIG. 8 setting the initial value (or the predicted value) of the dispersion-compensating value of wavelength channel M is produced based on the dispersion map of FIG. 6.

Next, the recording/calculation circuit 8 defines the variable a=−z so as to set an initial value of a dispersion-compensating value to DATAv (step S23). Herein, “z” denotes a predetermined scanning width. That is, the recording/calculation circuit 8 supplies a dispersion-compensating value, i.e. DATAv+a, to the dispersion compensator 5 (step S24). Then, the signal processing circuit 7 detects an error rate from an electric data signal so as to record it in the recording/calculation circuit 8 (step S25). A series of steps S24 to S26 is repeated until the variable a reaches z (where a=z).

That is, scanning is not performed on N divisions (DATA1 to DATAN) of the dispersion-compensable range shown in FIG. 4 but on 2z divisions (DATAv−z to DATAv+z) about the initial value DATAv of the dispersion-compensating value shown in FIG. 9, thus determining an optimum dispersion-compensating value of wavelength channel M. Then, the wavelength and the optimum dispersion-compensating value of wavelength channel M is recorded in the recording/calculation circuit 8 while the optimum dispersion-compensating value is set to the dispersion compensator 5. In other words, a dispersion-compensating value (e.g. DATAv) indicating a minimum error rate as shown in FIG. 9 is recorded in the dispersion map, while the optimum dispersion-compensating value DATAv is set to the dispersion compensator 5 (step S27). This completes the dispersion-compensating value setting process of wavelength channel M while updating the dispersion map.

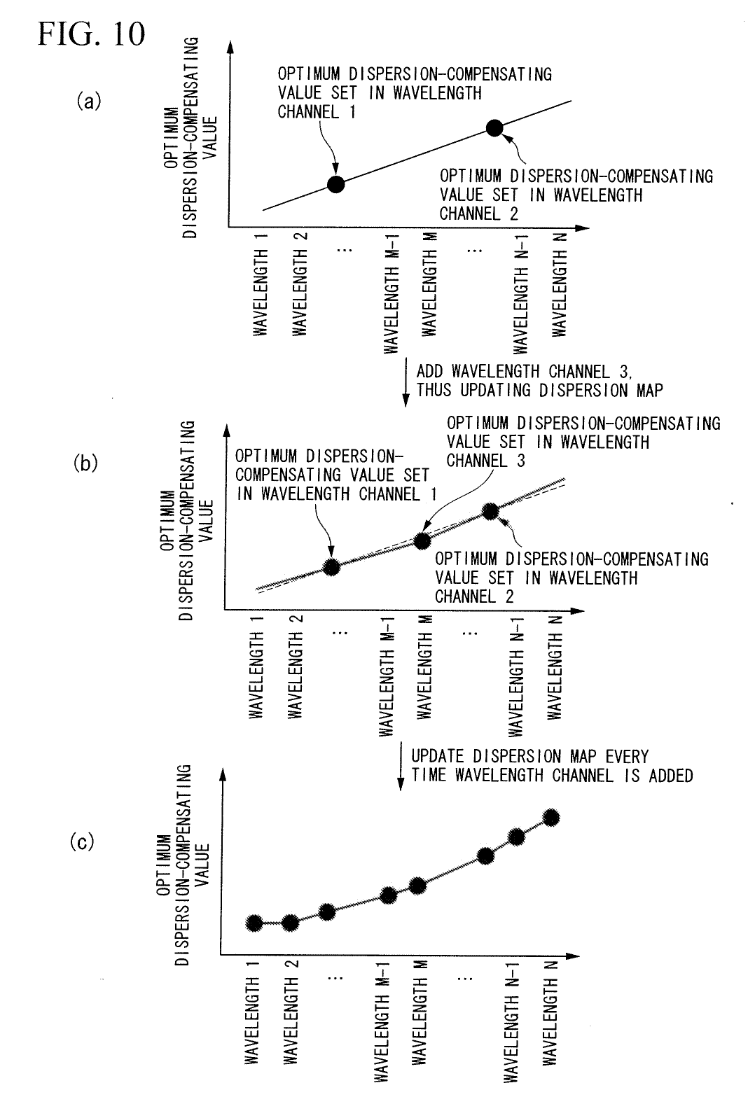

FIG. 10 shows a history of the dispersion map successively updated per added wavelength channel. FIG. 10(a) shows an original dispersion map without adding any wavelength channel; FIG. 10(b) shows a dispersion map updated per added wavelength channel M; and FIG. 10(c) shows a dispersion map updated per further added wavelength channels.

FIG. 10 shows a history of the dispersion map successively updated per added wavelength channels. Specifically, FIG. 10(a) shows a dispersion map in which a line is drawn between the optimum dispersion-compensating value of wavelength channel 1 and the optimum dispersion-compensating value of wavelength channel 2. FIG. 10(b) shows that the optimum dispersion-compensating value of added wavelength channel 3 and its center frequency M are recorded in the recording/calculation circuit 8, while the optimum dispersion-compensating value of wavelength channel 3 is added to the dispersion map. FIG. 10(c) shows that the dispersion map is updated by sequentially adding optimum dispersion-compensating values with respect to further added wavelength channels.

Thus, the recording content of the recording/calculation circuit 8 becomes large as the number of added wavelength channels increases, so that the dispersion map is successively updated as shown in FIG. 10(c) and improved in accuracy, thus decreasing distinctions between predicted initial values and optimum dispersion-compensating values with respect to added wavelength channels. As a result, it is possible to narrow down the scanning range of dispersion-compensating values as wavelength channels are successively increased, thus further shortening the time for setting optimum dispersion-compensating values.

### Embodiment 2

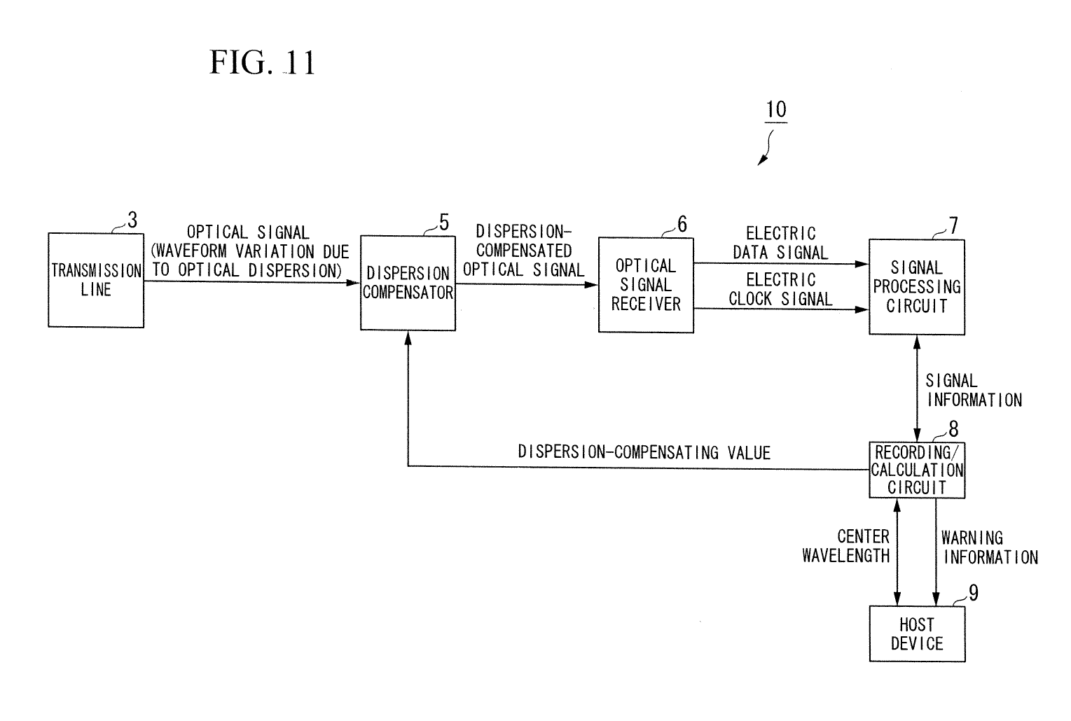

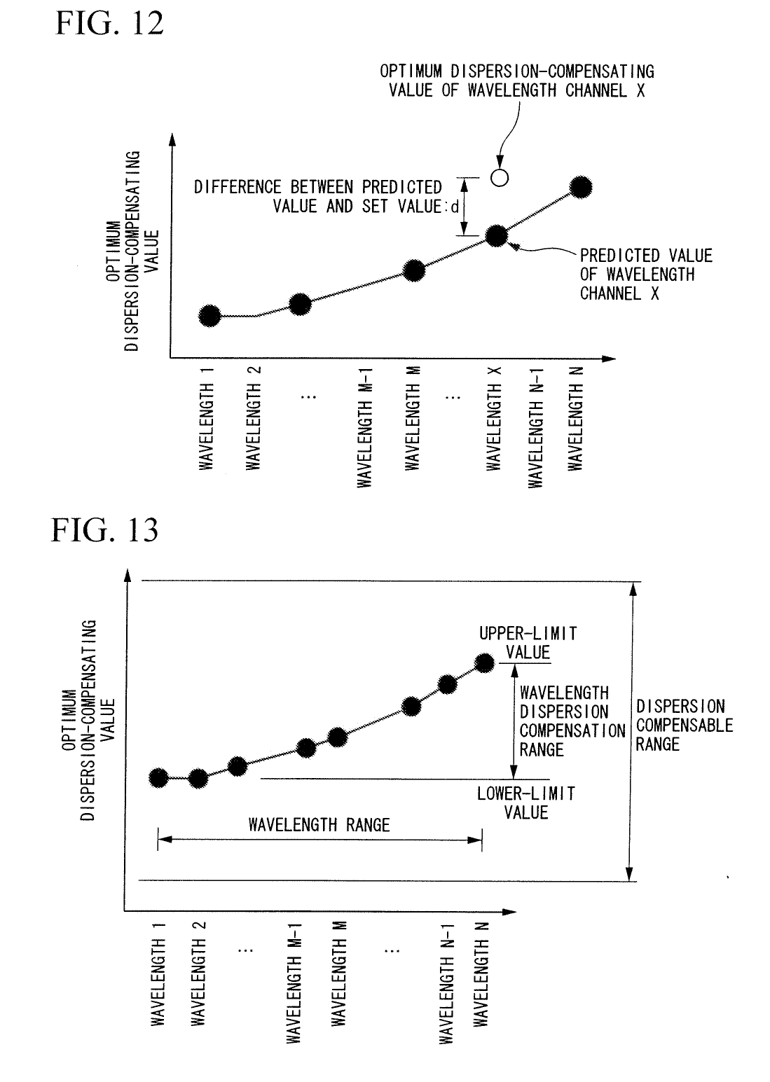

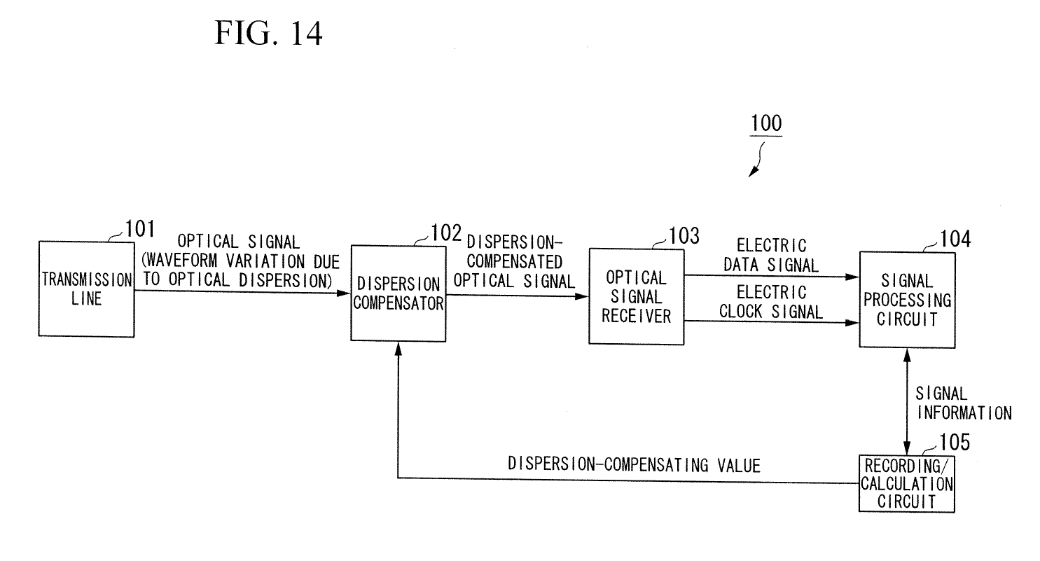

FIG. 11 is a block diagram showing essential parts of the wavelength multiplexing optical communication device according to Embodiment 2 of the present invention. In FIG. 11, the same constituent parts as those shown in FIG. 2 are designated by the same reference numerals. The constitution of Embodiment 2 shown in FIG. 11 differs from the constitution of Embodiment 1 shown in FIG. 2 in that the host device 9 receives warning information, regarding dispersion-compensating values, from the recording/calculation circuit 8. FIG. 12 shows a dispersion map which is produced by the wavelength multiplexing optical communication device 10 of Embodiment 2, wherein the horizontal axis represents the wavelength, and the vertical axis represents the optimum dispersion-compensating value.

In Embodiment 2, the recording/calculation circuit 8 detects differences between optimum dispersion-compensating values of wavelength channels and predicted values of dispersion-compensating values of wavelength channels, which are predicted based on the dispersion map, and notifies them to the host device 9. If large differences are found between optimum dispersion-compensating values and predicted values of dispersion-compensating values, the recording/calculation circuit 8 transmits warning information to the host device 9.

In FIG. 12, the recording/calculation circuit 8 predicts a dispersion-compensating value of wavelength channel X (wavelength X) based on the dispersion map, detects a difference d between the predicted value and the optimum dispersion-compensating value of wavelength channel X, and notifies it to the host device 9. The host device 9 notifies warning information to an external device when the difference d is larger than a predetermined threshold.

Dispersion variation of the optical fiber constituting the transmission line 3 depends on the wavelength of a selected wavelength channel, whereas dispersion variation is relatively moderate so that rapid dispersion variation does not occur. For this reason, optimum dispersion-compensating values are varied in a moderate manner. Therefore, the recording/calculation circuit 8 sends warning information to the host device 9 when a difference between an optimum dispersion-compensating value and a predicted value of a dispersion-compensating value predicted based on the dispersion map is larger than the predetermined threshold.

As described above, the recording/calculation circuit 8 sends a warning to the host device 9 since the optimum dispersion-compensating value is regarded as an abnormal value when the difference d between the optimum dispersion-compensating value and the predicted value of the dispersion-compensating value predicted based on the dispersion map exceeds the predetermined threshold. That is, the wavelength multiplexing optical communication device 10 compares the optimum dispersion-compensating value with the predicted value of the dispersion-compensating value based on the dispersion map, and sends a warning that some drawback may occur in the transmission line 3, the dispersion compensator 5, or the optical dispersion compensation method when a large difference therebetween is found.

### Embodiment 3

FIG. 13 shows a dispersion map which is produced by the wavelength multiplying optical communication device 10 according to Embodiment 3 of the present invention, wherein the horizontal axis represents wavelength, and the vertical axis represents optimum dispersion-compensating value. The Embodiment 3 is designed to calculate an upper-limit value and a lower-limit value of a wavelength dispersion-compensable range, corresponding to a predetermined wavelength range, with reference to the dispersion map shown in FIG. 13. That is, the Embodiment 3 does not scan the entire dispersion-compensable range of the dispersion compensator 5, but scans the wavelength dispersion-compensable range, between the upper-limit value and the lower-limit value, which is used for determining the optimum dispersion-compensating value. In other words, the Embodiment 3 calculates the upper-limit value and the lower-limit value defining the wavelength dispersion-compensable range, corresponding to the wavelength range used for determining the optimum dispersion-compensating value, so as to limit the scanning range, thus shortening the time for setting the optimum dispersion-compensating value.

The wavelength multiplexing optical communication device and the optical dispersion compensation method according to the present embodiment are described in conjunction with Embodiments 1 to 3; but the present invention is not necessarily limited to the foregoing embodiments, which can be further modified in various ways within the scope of the invention defined by the appended claims.

It is possible to realize the optical dispersion compensation method, applied to the wavelength multiplexing optical communication device according to the present invention, in programs which are loadable and executable by a computer. That is, it is possible to store programs, implementing the optimum dispersion-compensating value setting process involved in the optical dispersion compensation method, in computer-readable recording media, thus enabling a computer to load and execute programs. As computer-readable recording media, it is possible to name magnetic disks, magnetooptic disks, CD-ROM (Compact Disk Read-Only Memory), DVD-ROM (Digital Versatile Disk Read-Only Memory), and semiconductor memory.

### INDUSTRIAL APPLICABILITY

The present invention is applied to the optical dispersion compensation in the wavelength multiplexing optical communication device, which predicts an initial value of a dispersion-compensating value per a newly added wavelength channel with reference to a dispersion map of a transmission line which is produced based on existing wavelength channels, thus starting scanning at the initial value and determining the optimum dispersion-compensating value. Thus, it is possible to significantly shorten the time for setting the optimum dispersion-compensating value per each wavelength channel. Therefore, the present invention effectively functions when applied to optical communication devices in communication networks using optical fibers.

### DESCRIPTION OF THE REFERENCE NUMERALS

1 Optical signal transmitter
2 Optical multiplexer
3 Transmission line
4 Optical splitter
5 Individual dispersion compensator
6 Optical signal receiver
7 Signal processing circuit
8 Recording/calculation circuit
9 Host device
10 Wavelength multiplexing optical communication device

1. A wavelength multiplexing optical communication device having an optical dispersion-compensating function compensating for waveform variation of an optical signal due to optical dispersion of a transmission line, said wavelength multiplexing optical communication device comprising:
producing a dispersion map of the transmission line based on optimum dispersion-compensating value which are already determined with respect to pre-installed wavelength channels;
predicting an initial value of a dispersion-compensating value per a newly added wavelength channel with reference to the dispersion map; and
starting scanning at the initial value of the dispersion-compensating value, determining an optimum dispersion-compensating value of the newly added wavelength channel, and updating the dispersion map.

2. A wavelength multiplexing optical communication device having an optical dispersion-compensating function compensating for waveform variation of an optical signal due to optical dispersion of a transmission line, said wavelength multiplexing optical communication device comprising:
a signal processing circuit that scans dispersion-compensating values of pre-installed wavelength channels so as to determine optimum dispersion-compensating values causing a minimum error rate; and
a recording/calculation circuit that produces a dispersion map based on the optimum dispersion-compensating values, predicts an initial value of a dispersion-compensating value per a newly added wavelength channel with reference to the dispersion map, and determines an optimum dispersion-compensating value of the newly added wavelength channel, thus updating the dispersion map.

3. The wavelength multiplexing optical communication device according to claim 2, wherein the recording/calculation circuit issues warning information when a difference between the optimum dispersion-compensating value and a predicted value of a dispersion-compensating value predicted based on the dispersion map becomes larger than a predetermined threshold.

4. The wavelength multiplexing optical communication device according to claim 2, wherein the recording/calculation circuit determines an upper-limit value and a lower-limit value defining a wavelength dispersion-compensable range, corresponding to a wavelength range used for scanning dispersion-compensating values per wavelength channel, and scans the wavelength dispersion-compensable range to set the optimum dispersion-compensating value.

5. An optical dispersion compensation method compensating for waveform variation of an optical signal due to optical dispersion of a transmission line in wavelength multiplexing communication, said optical dispersion-compensating method comprising:
determining optimum dispersion-compensating values causing a minimum error rate with respect to pre-installed wavelength channels;
producing a dispersion map of the transmission line based on the optimum dispersion-compensating values;
predicting an initial value of a dispersion-compensating value per a newly added wavelength channel with reference to the dispersion map;
starting scanning at the initial value so as to determine an optimum dispersion-compensating value of the newly added wavelength channel; and
updating the dispersion map by adding the optimum dispersion-compensating value of the newly added wavelength channel.

6. An optical dispersion compensation method according to claim 5, wherein warning information is sent when a difference between an optimum dispersion-compensating value and a predicted value of a dispersion-compensating value, which is predicted based on a dispersion map, is larger than a predetermined threshold.

7. A non-transitory computer-readable storage medium storing a program, describing an optical dispersion compensation method compensating for wavelength variation of an optical signal due to optical dispersion of a transmission line in wavelength multiplexing optical communication, loaded and executed by a computer, comprising:
determining optimum dispersion-compensating values causing a minimum error rate with respect to pre-installed wavelength channels;
producing a dispersion map of the transmission line based on the optimum dispersion-compensating values;
predicting an initial value of a dispersion-compensating value per a newly added wavelength channel with reference to the dispersion map;
starting scanning at the initial value so as to determine an optimum dispersion-compensating value of the newly added wavelength channel; and
updating the dispersion map by adding the optimum dispersion-compensating value of the newly added wavelength channel.

8. The non-transitory computer-readable storage medium storing the program according to claim 7, wherein warning information is sent when a difference between an optimum dispersion-compensating value and a predicted value of a dispersion-compensating value, which is predicted based on a dispersion map, is larger than a predetermined threshold.
